(19) United States
(12) Patent Application Publication
(10) Pub. No.: US 2022/0139271 A1
(43) Pub. Date: May 5, 2022

(54) PATTERN OF NESTED RECTANGLES OF DIFFERENT COLORS OVERLAID WITH GLITTER ON AN OUTER REGION OF A PRESENTATION BOARD

(71) Applicant: Royal Consumer Products LLC, Norwalk, CT (US)

(72) Inventors: Timmy Koletsos, Shelton, CT (US); Steven A. Schulman, Fairfield, CT (US)

(73) Assignee: Royal Consumer Products LLC, Norwalk, CT (US)

(21) Appl. No.: 17/577,282

(22) Filed: Jan. 17, 2022

Related U.S. Application Data
(63) Continuation-in-part of application No. 29/701,818, filed on Aug. 14, 2019.

(51) Int. Cl. G09F 7/02

(52) U.S. Cl. CPC G09F 7/02

(57) ABSTRACT

A presentation board having an outer peripheral region with nested rectangles each of a different ink color printed upon it that are indicative of colors found in a rainbow pattern. Glitter is overlaid to cover the nested rectangles. The inner central region of the presentation is devoid of the nested rectangles.

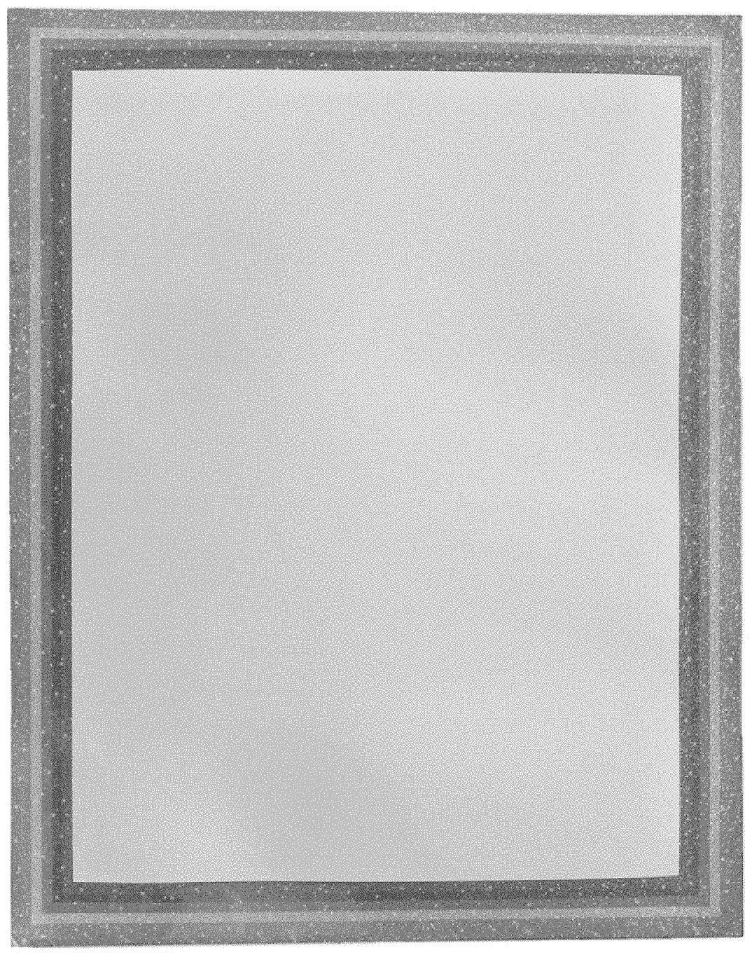

### CROSS-REFERENCE TO RELATED APPLICATIONS

The present application is a continuation-in-part of design patent application no. 29/701,818 filed Aug. 14, 2019.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### (1) Field of the Invention

The invention pertains to glitter framed poster boards.

### (2) Description of Related Art

Including Information Disclosed Under 37 CFR 1.97 and 1.98

Presentation boards may be in the form of a posterboard/display board, a foamboard/foam core board, or a project board/folded display board. Posterboards or display boards are relatively lightweight and made of thick, fairly stiff cardboard composed of layers of paper or paper pulp compressed together and typically used to support displays. The cardboard may be either paperboard, corrugated fiberboard and/or cardstock. Foamboard or foam core board is more rigid than posterboards and has a lightweight foam core that is sandwiched between white paper. A project board or a folded display board has creases that enable adjacent panels to fold relative to each other but is otherwise of the same construction as the posterboard or display board.

According to en.wikipedia.org/wiki/Mat_(picture_framing):

The picture-framing mat is most commonly known by laymen for its use as additional decoration to enhance the look of a framed piece, sometimes in conjunction with a fillet or more rarely, liners made of wooden moulding with a cloth surface. Although matting usually contains only one opening per layer, it may contain none if a picture is “float-mounted” or “top-mounted” (placed on top of the mat), and mats with two or more exist, more commonly with photography of the family or pictures of individual family members type than other types of artwork. Typically the mat or mats, if matched carefully and properly proportioned, serve to help draw the eye in towards the framed piece, or towards a particular key element of the piece. However, while the mat is usually regarded as something to complement or set off the artwork to best effect, or not to interfere or compete with it (neutral-colored mats are often preferred by high-end art galleries) there are some examples of the mat being regarded by the artist as a part of the artwork.

What has been heretofore missing from presentation boards that are available commercially is a pattern of nested rectangles of different colors each overlaid with glitter in the outer region.

### SUMMARY OF THE INVENTION

One aspect of the invention resides in a presentation board having an outer region upon which is a pattern of nested rectangles each of a different solid color and overlaid with glitter. The different solid colors can be arranged in sequence to correspond to the sequence of solid colors that are perceived by the eye in a natural rainbow or in a rainbow of colors from light passing through a prism. The presentation board may be a posterboard, a display board, a foamboard, a foam core board, a display board, a folded display board or a project board.

### BRIEF DESCRIPTION OF THE DRAWING

For a better understanding of the present invention, reference is made to the following description and accompanying drawing, while the scope of the invention is set forth in the appended claims. The patent or application file contains at least one drawing executed in color. Copies of this patent or patent application publication with color drawing(s) will be provided by the Office upon request and payment of the necessary fee.

The drawing shows a top view of a posterboard that is flat and having nested rectangles printed upon an outer region of the posterboard. Each of the nested rectangles are a different solid color and overlaid with sprinkles that shine or glisten in the light and bound a central, inner region of the posterboard that lacks such nested rectangles. The bottom view of the posterboard is not shown but is flat and of the same color in its entirety as that of the central, inner region of the top view. The posterboard is very thin with a flat peripheral edge surface so the front, rear, left side and right side views are omitted.

### DETAILED DESCRIPTION OF THE INVENTION

The drawing depicts a presentation board in the form of a conventional, rectangular posterboard, but which is modified in accordance with the invention to have nested rectangles each of a different solid color printed upon an outer region of the posterboard. Each of the printed, nested rectangles are overlaid with glitter that is adhered on top of the printed, nested rectangles. An outer region of the posterboard therefore underlies the printed, nested rectangles and is made of the same material and thickness as that of the central inner region of the posterboard that is visible in the drawing.

There are six, printed, nested rectangles depicted whose innermost edge bounds the central inner region of the posterboard and whose outermost edge aligns with the outer periphery of the posterboard. The central inner region of the posterboard lacks any of the printed, nested rectangles. Although the overlaid glitter is applied only to printed, nested rectangles, some of the glitter may flake off and reside temporarily within the central inner region of the posterboard, but the central inner region may be characterized as being substantially glitter-free. Each of the nested rectangles may have the same width.

The present invention is a modification of U.S. design patent application Ser. No. 29/701,818, whose drawing depicts a pattern constituted by a glitter frame within a “frame” of a posterboard. That is, the posterboard's outer periphery serves as a kind of outer frame of the unitary-colored, rectangular frame shape covered with glitter, which in turn frames the central region of the posterboard. In that sense, the central region of the posterboard appears to have to frames nested one inside the other that bound it. The outermost one just happens to be the same color as the posterboard and lacks glitter.

The present inventor came up with the concept of adding a pattern of different colors in the outer peripheral region of a posterboard or a foamboard that are set forth as nested, rectangles each overlaid with glitter. In that way, such a pattern help directs the eye to look from the outside of the posterboard or foamboard first and then toward the inner center region where items typically applied to any conventional posterboard by a user.

The solid colors of the pattern of nested rectangles preferably differ from each other to and preferably arranged in a sequence of colors corresponding to a sequence of colors expected in a rainbow, whether the number of rectangular frame shapes be five, six or seven colors. For instance, for seven colors, the order of colors may be R, O, Y, G, B, I, V or the reverse, where R is red, O is orange, Y is yellow, G is green, B is blue, I is indigo and V is violet.

While the rainbow spectrum of colors could correspond to the colors of a natural rainbow or a rainbow of colors that appears from shining a light through a prism, the colors do not need to correspond are even to set forth in the same order of sequence or its reverse. The colors B, I, V appear somewhat darker than the colors R, O, Y, G. Thus, to obtain the strongest contrast between the white color of the central region of the posterboard with the nested rectangles, the colors B, I, V should be closer to the white color central region than the colors R, O, Y, G.

The drawing shows the colors red, orange, yellow, green, blue and violet. Within the meaning of the invention, such six colors constitute a rainbow spectrum of colors. By providing violet as the innermost color of the nested rectangles, such creates a stronger contrast adjacent to the white central region of the poster board then would be the case for red. The colors pink, purple and even magenta may to be treated as viable colors for providing a rainbow spectrum of colors according to britannica.com/video/152179/1saac-Newton-formulation-law-gravitation:

When Isaac Newton originally observed a rainbow of light split by a prism and made his labeling of the colors as red, orange, yellow, green, blue, indigo, violet, the thing he called blue was indeed what we would now call blue-green, or teal, or cyan. Reminiscent of the color of the blue sky. And what we now tend to call blue, Newton called violet, as in, roses are red violets are blue. Dark blue . . . .

Purple, magenta, and hot pink, as we know, don't occur in the rainbow from a prism because they can only be made as a combination of red and blue light. And those are on opposite sides of the rainbow, nowhere near overlapping. So there is no purple or hot pink in the rainbow from a prism . . . .

I suspect sometimes it's an optical illusion whereby nice deep blues in small amounts surrounded by a lighter color appear purplish to our eyes. However, sometimes purple and pink really are there because a rainbow is really a rain disk. Each color of sunlight reflects back in a bright rimmed disk, all of different sizes, which together add up to make a white disk with a colorful rim.

But because light is a wave, interference from the raindrops themselves actually gives each disk multiple rings. The familiar outer ring is just the brightest. The others are called supernumerary rings and are the source of supernumerary rainbows. The smaller the raindrops, the stronger the supernumerary bows. And if the drops are the right size, the first red supernumerary ring can overlap significantly with the main violet ring. And what do red and violet give? Purple.

The manner of manufacture of the invention involves: Step 1: 4/0 Printing of color rectangles; Step 2: Glitter application to the color rectangles; Step 3: High temperature and high pressure to keep the shape of the rectangles and retain glitter in place.

The number “4/0” signifies full color on one side, blank on the other. Such a numeric designation is known, for instance, from mdesignonline.com/blog/graphic-design/color-printing-what-does-40-41-and-44-mean/. The article also describes four-color printing as follows.

About CMYK, Known As Four-Color Printing

The four-color print process . . . uses the four primary colors of cyan, magenta, yellow and black to produce all the colors you see in normal print magazines and books. In some cases, six colors are used, but these are much less common; most printing is produced with the four-color technique.

In fact, most commercial printers use the CMYK method to print full-color. In addition, they can do something called “spot varnish,” and then use “spot color” besides, or separate spots of colors beyond that included in the main printed piece. This can make a four-color print job become a six color print job. That is because six colors of ink will be used for the finished product.

A conventional commercial 4/0 printing machine, such as one manufactured by the German company of “Heidelberg” under the model name of “Speedmaster CX102-5”, is used to print colored rectangles in a nested manner on the presentation board in accordance with the invention. A conventional commercial glitter depositing machine, such as one manufactured by the Chinese company of “Hangzhou Tao Xing Printing Equipment Company Ltd.” of Hangzhou, Zhengjiang, China, under the model name “TX-ZDFS01”, is used to apply glitter atop the printed ink on the presentation board in accordance with the invention.

In lieu of printing directly onto the presentation board, the printing may be effected onto one sided adhesive coated paper strips instead. The strips are then cut accordingly and arranged into rectangles and adhered to the presentation board in a nested manner. Glitter may then be applied. In that sense, the technique set forth in U.S. Pat. No. 10,974,542, whose contents are incorporated herein by reference, may be used instead. The glitter applying equipment may deposit the glitter, whether small or large size as described in that patent, under high temperature and high pressure (such as at a temperature of 400 degrees Fahrenheit under a pressure of 8500 pounds per meter for a three second dwell time).

While the foregoing description and drawings represent the preferred embodiments of the present invention, various changes and modifications may be made without departing from the scope of the present invention.

What is claimed is:

1. A decorative product that appears to have a frame, comprising:
a presentation board having an inner region and an outer region, the presentation board being selected from the group consisting of a posterboard, a foam board, a foam core board, a display board, a folded display board and a project board;
a plurality of nested rectangles arranged one inside the other within the outer region only, each of the nested rectangles being of a different solid color than that of adjacent ones of the nested rectangles and arranged to exhibit a pattern of the different solid colors one after another in succession via the nested rectangles; and
glitter adhered to and overlying each of the nested rectangles, the glitter having a reflective quality to glisten upon exposure to light shining on the glitter,
wherein the inner region lacks any of the nested rectangles, the inner region being bounded by an innermost one of the nested rectangles that is within the outer region.

2. The decorative product of claim 1, wherein the different solid colors of the nested rectangles are arranged in a sequence corresponding to a sequence expected for the solid colors in a rainbow, the different solid colors being selected from the group consisting of red, pink, orange, yellow, green, blue, cyan, indigo, purple, violet and magenta.

3. The decorative product of claim 2, wherein the different solid colors include in sequence the solid colors of red, orange, yellow, green, blue and violet.

4. The decorative product of claim 1, wherein the presentation board has cardboard composed of layers each selected from the group selected from paper pulp compressed together, paperboard, corrugated fiberboard, cardstock, and foam core that is sandwiched between paper.

5. The decorative product of claim 1, wherein the inner region of the presentation board is of a different color than that of any of the nested rectangles and lacks the glitter.

6. The decorative product of claim 1, wherein the different solid colors are formed by respective layers of ink that correspond in color to the different solid colors.
